(19) United States
(12) Patent Application Publication
(10) Pub. No.: US 2004/0221435 A1
(43) Pub. Date: Nov. 11, 2004

(54) Tubular shaped combination casket/burial vault with end caps or end plugs for the lid or cover

(76) Inventor: Zane W. Pentz, Fillmore, UT (US)

Correspondence Address: Zane Wade Pentz, 315 South 100 West, Fillmore, UT, 84631, US

(21) Appl. No.: 10/429,401

(22) Filed: May 6, 2003

(51) Int. Cl. A61G 17/00

(52) U.S. Cl. 27/35

(57) ABSTRACT

Tubular shaped Combination Casket/Burial Vault with end caps or end plugs for the lid or cover. The tube may vary in shape such as square, circular, rectangular, or oval etc. and vary in materials such as plastic, polyvinyl chloride, polyethylene aluminum, coated steel, concrete, fiberglass or any other material etc of sufficient strength to serve as the intended need for a vault. On the market pipe products varying in shape and materials may be used for the tube material. The tube shape eliminates the traditional top lid or cover and allows either end of the tube to be used to insert the body into the said casket/burial vault.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention correlates to the containment of the remains of a body whether human or animal. Most cities are requiring caskets to be placed in burial vaults to comply with health codes. The burial vaults are an added expense for the funeral. The said combination burial vault/casket will eliminate the added expense for the separate burial vault. There are other products and patents on combination burial vaults/caskets but all of these have the traditional base with a hinged lid or cover. The said tubular shaped burial vault/casket does not have the base with the hinged lid or cover but rather with its tubular shape the lid and/or cover are at the ends of the tube where the body is inserted.

### BRIEF DESCRIPTION OF THE SEVERAL VIEWS OF THE DRAWING

Not Applicable. No drawing is attached.

### DETAILED DESCRIPTION OF THE INVENTION

1. Tubular shaped Combination Casket/Burial Vault with end caps or end plugs for the lid or cover.

2. The tube may vary in shape such as square, circular, rectangular, or oval etc.

3. The tube may vary in materials such as plastic, polyvinyl chloride, polyethylene aluminum, coated steel, concrete, fiberglass or any other material etc.

4. On the market pipe products varying in shape and materials may be used for the tube material.

5. The tube shape eliminates the traditional top lid or cover and allows either end of the tube be used for access into the said tubular shaped casket/burial vault system.

6. End caps or end plugs matching the shape of the tube and made of various materials are used for the lid or cover for the ends of the tube shaped casket/burial vault.

7. The end cap or end plugs are sealed onto the tube to provide a water/air tight seal with glue, rubber gaskets or any other methods to seal the cap or plug to the end of the tube.

8. Carrying handles or rods can be incorporated onto the tubular casket/burial vault system to make ease of handling and manual transportation.

9. The system may be painted to a suitable color.

10. The system may be used for different methods of containing the dead other than the traditional underground burial with the body laying horizontal.

What I claim as my invention is:

1. A combined burial vault and casket is less expensive than the separate burial vault and casket.

2. Does not have the basic appearance as conventional caskets of today because of its tubular shape with end caps or plugs for the lid or cover.

3. The tube shaped casket/burial vault system is unlike any other burial system invention in appearance.

4. Access for the system is from the ends of the tube rather than a lid and/or cover for laying the body into the casket.

5. The system may be made of lightweight materials for manual transportation and placement.

6. The gasketed and/or glued end caps or plugs seals the vault/casket system from moisture or air leakage required by most perpetual care cemeteries.

7. The durable materials will provide the strength needed for the vault to eliminate sink holes required by most perpetual care cemeteries.
